(19) United States
(12) Patent Application Publication
(10) Pub. No.: US 2019/0278429 A1
(43) Pub. Date: Sep. 12, 2019

(54) MANUFACTURING A TOUCH SENSOR

(71) Applicant: INTEL CORPORATION, Santa Clara, CA (US)

(72) Inventors: Dong Yeung Kwak, San Jose, CA (US); Ramon C. Cancel Olmo, Hillsboro, OR (US); Jue Li, Shanghai (CN); Jie Sun, Shanghai (CN)

(73) Assignee: INTEL CORPORATION, Santa Clara, CA (US)

(21) Appl. No.: 16/462,399

(22) PCT Filed: Dec. 19, 2016
(86) PCT No.: PCT/CN2016/110687

§ 371 Date: May 20, 2019

(51) Int. Cl. G06F 3/044; B41J 3/407

(52) U.S. Cl. CPC G06F 3/0446; G06F 2203/04103; B41J 3/4073

(57) ABSTRACT

An electronic device (400) for manufacturing a touch sensor is described. The electronic device (400) includes a printer (418) to print a first pattern and a second pattern on a first side of a first substrate (202). The first pattern is parallel to movement of a print head (206). The first pattern and the second pattern are perpendicular to each other. The electronic device (400) also includes a rotator (420) to rotate the first substrate (202) so that the printer (418) is to print the second pattern parallel to the movement of the print head (206).

### TECHNICAL FIELD

The present disclosure relates to techniques for manufacturing a touch sensor for a touch screen. In some examples, the present techniques may relate to creating a pattern on a touch sensor by reverse ink jet printing.

### BACKGROUND ART

A touch screen is an input/output device normally layered on top of a visual display of an information processing system. The touch screen may enable a user to interact directly with what is displayed, rather than using a mouse, touchpad, or any other intermediate device. Advances in technology are making it possible for touch screens to be used in an increasing number of electronic applications.

### BRIEF DESCRIPTION OF THE DRAWINGS

FIG. 1A is an image of a pattern of electrodes formed by reverse ink jet printing.

FIG. 1B is an image of a pattern of electrodes substantially perpendicular to the pattern in FIG. 1A.

FIG. 2 is a representation of a system that allows for rotation of a substrate.

FIG. 3 is a representation of the system in FIG. 2 after rotation of the substrate.

FIG. 4 is a block diagram of an electronic device for manufacturing a touch sensor.

FIG. 5 is a process flow diagram of a method for manufacturing a touch sensor.

FIG. 6 is a simplified flow diagram of the method shown in FIG. 5.

FIG. 7 is a block diagram of a medium containing code to execute the manufacture of a touch sensor.

FIG. 8A is a representation of a printed pattern obtained using the touch sensor manufacturing techniques discussed herein.

FIG. 8B is a representation of a printed pattern substantially perpendicular to the printed pattern in FIG. 8A.

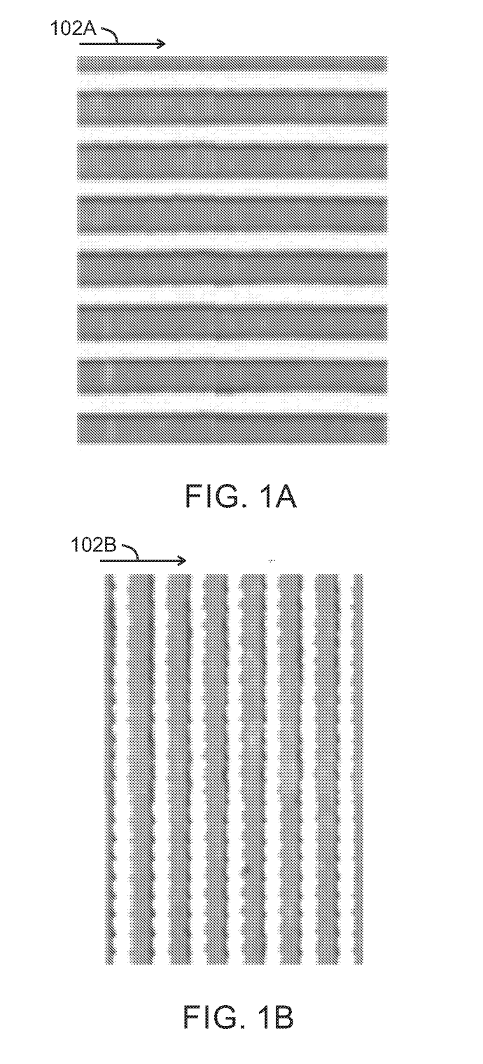

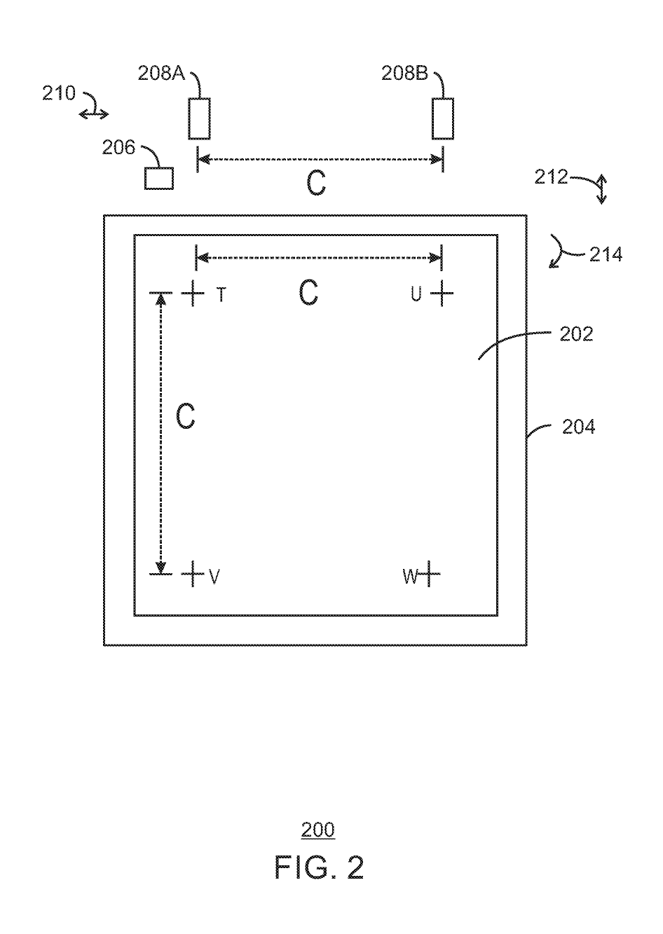

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Capacitive touch screens may be composed of a grid of rows and columns of conductive materials such as copper, indium tin oxide (ITO) or silver nano wire (SNW) layered on a substrate such as glass. A capacitor may be formed at the intersections of the row electrodes and column electrodes at each point on the grid. Voltage applied to the grid may create a uniform electrostatic field, which can be measured. Bringing a finger or other conductive object close to the surface of a capacitive touch screen may change the local electrostatic field which reduces the mutual capacitance. The capacitance change at every point of intersection on the grid may be measured so that the location of the touch can be accurately determined. Software may process the location of the touch and command an appropriate ensuing action.

Capacitive touch screens may be manufactured in a number of ways. For example, manufacturing methods may include etching a single conductive layer to form the grid pattern of electrodes. Another method may entails etching two separate, perpendicular layers of conductive material. Yet another method is reverse ink jet printing. This method may use a print head to remove conductive material from a substrate, leaving the grid pattern. The conductive material used in reverse ink jet printing is often SNW.

FIG. 1A is an image of a pattern of electrodes formed by reverse ink jet printing. The white bars represent the electrodes of the conductive material while the gray bars represent the substrate exposed by the print head. The direction of movement of the print head is indicated by the arrow 102A. The pattern in this figure is substantially parallel, i.e., parallel within a tolerance of plus or minus 5°, to the direction 102A of movement of the print head. The edges of the white bars are well-defined and substantially straight in this figure.

FIG. 1B is an image of a pattern of electrodes substantially perpendicular to the pattern in FIG. 1A. As in FIG. 1A, the white bars represent the electrodes of the conductive material and the gray bars represent the substrate exposed by the print head. The direction of movement of the print head is indicated by the arrow 102B. The pattern in this figure is substantially perpendicular to the direction 102B of movement of the print head. The edges of the white bars are jagged in this figure. Jagged edges on adjacent electrodes may come into contact with one another and short out the grid when the electrodes are close together as in a higher resolution touch screen used in a small application product.

In some embodiments, the subject matter disclosed herein relates to techniques for printing perpendicular electrodes without jagged edges. This may be accomplished by printing electrodes that are parallel to the direction of movement of the print head, rotating the substrate, and printing a second set of electrodes parallel to the direction of movement of the print head. In this fashion, there is no printing of electrodes perpendicular to the direction of movement of the print head. Accordingly, in some embodiments, none of the electrodes have jagged edges.

In the following description, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

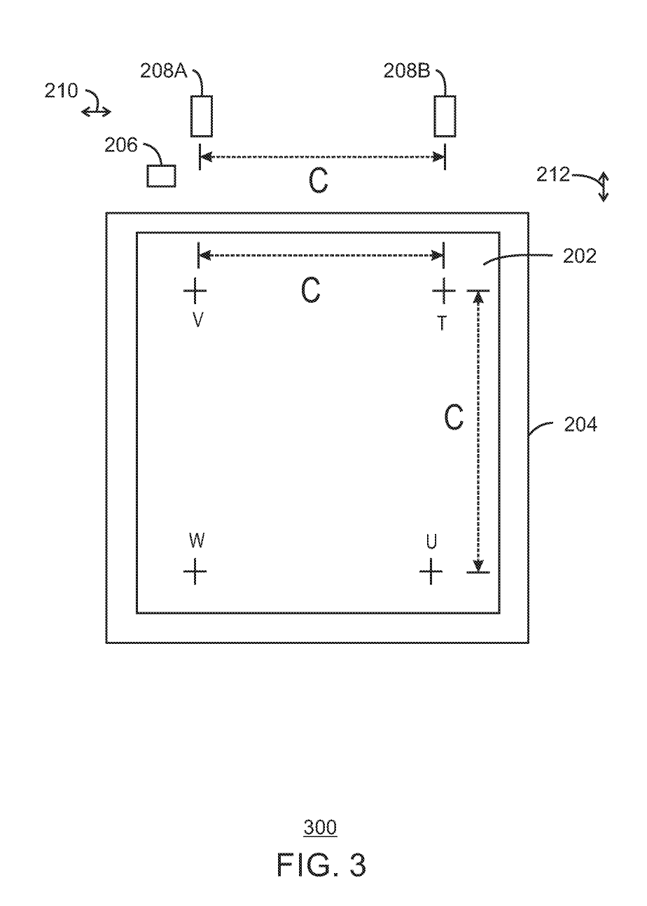

FIG. 2 is a representation of a system 200 that allows for rotation of a substrate. FIG. 2 depicts the system 200 before rotation. As depicted in FIG. 2, the substrate 202 may be positioned on the printer stage 204. The substrate 202 may be aligned with the print head 206 by aligning the fixed cameras 208A and 208B with the alignment marks T and U on the substrate 202. Alignment of the cameras 208A and 208B with the alignment marks T and U may be possible because the alignment marks T and U are the same distance apart as the fixed cameras 208A and 208B. This distance is represented by C in FIG. 3.

Once alignment is achieved, the pattern parallel to the direction of movement of the print head 206 may be printed with the print head 206 moving in the direction indicated by the arrow 210 and the printer stage 204 moving in the direction indicated by the arrow 212. The substrate 202 may be rotated in the direction indicated by arrow 214.

FIG. 3 is a representation of the system 200 in FIG. 2 after rotation of the substrate 202. The substrate 202 may be aligned with the print head 206 by aligning the fixed cameras 208A and 208B with the alignment marks T and V on the substrate 202. After rotation, alignment may be possible because the distance C between alignment marks T and V is the same as the distance between alignment marks T and U. If the distance between alignment marks T and V were different than the distance between alignment marks T and U, alignment of the substrate after rotation would not be possible. Alignment marks T and V would not line up with the fixed cameras 208A and 208B. Printing on the rotated substrate could not occur because of the misalignment of the substrate and the print head.

The substrate 202 and the print head 206 of rotated system 300 may be aligned. A second pattern may be printed with the print head 206 moving in the direction indicated by the arrow 210 and the printer stage 204 moving in the direction indicated by the arrow 212. Because of the rotation of system 300, the second pattern may also be printed in a direction parallel to the direction 210 of the movement of the print head 206. As a result, a grid may be formed and the second pattern may not have jagged edges.

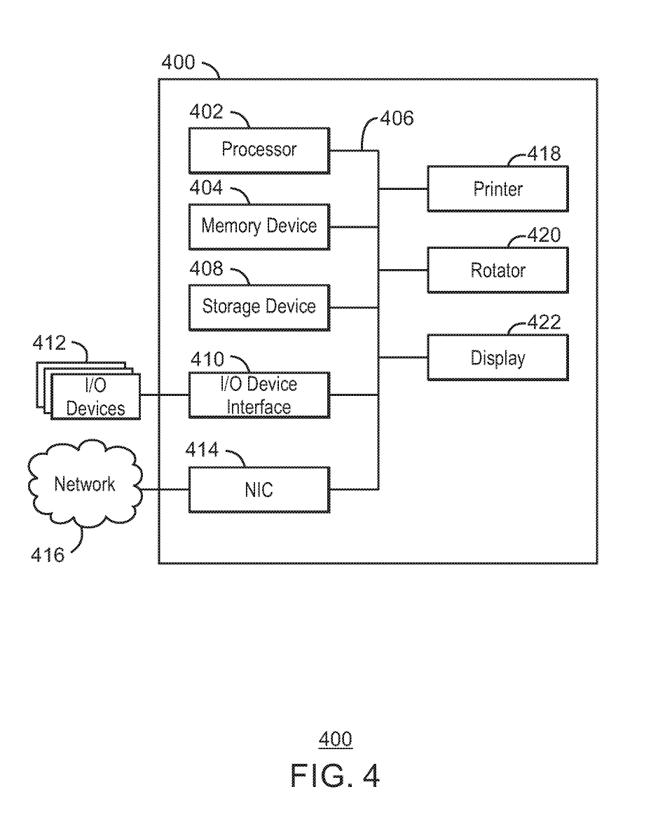

FIG. 4 is a block diagram of an electronic device 400 for manufacturing a touch sensor. The electronic device 400 may include a processor 402 that is configured to execute stored instructions, as well as a memory device 404 that stores instructions that are executable by the processor 402. The processor 402 may be coupled to the memory device 404 by a bus 406. The processor 402 may be a single core processor, a multi-core processor, a computing cluster, or any number of other configurations. The processor 402 may be implemented as a Complex Instruction Set Computer (CISC) processor, a Reduced Instruction Set Computer (RISC) processor, x86 Instruction set compatible processor, or any other microprocessor or processor. In some embodiments, the processor 402 includes dual-core processor(s), dual-core mobile processor(s), or the like.

The memory device 404 may include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory system. The memory device 404 can be used to store data and computer-readable instructions that, when executed by the processor 402, direct the processor 402 to perform various operations in accordance with embodiments described herein.

The electronic device 400 may also include a storage device 408. The storage device 408 is a physical memory device such as a hard drive, an optical drive, a flash drive, an array of drives, or any combinations thereof. The storage device 408 may store data as well as programming code such as device drivers, software applications, operating systems, and the like. The programming code stored by the storage device 408 may be executed by the processor 402 or any other processors that may be included in the electronic device 400.

The electronic device 400 may also include an input/output (I/O) device interface 410 configured to connect the electronic device 400 to one or more I/O devices 412. For example, the I/O devices 412 may include a scanner, a keyboard, and a pointing device such as a mouse, touchpad, or touchscreen, among others. The I/O devices 412 may be built-in components of the electronic device 400, or may be devices that are externally connected to the electronic device 400.

The electronic device 400 may also include a network interface controller (NIC) 414 configured to connect the electronic device 400 to a network 416. The network 416 may be a wide area network (WAN), local area network (LAN), or the Internet, among others.

The electronic device 400 may further include a printer 418. The printer 418 may print a first pattern and a second pattern on a first side of a first substrate. The first pattern may be parallel to a direction of movement of a print head. The first pattern and the second pattern may be perpendicular to each other.

The electronic device 400 may also include a rotator 420. The rotator 420 may rotate the first substrate so that the printer prints the second pattern parallel to the movement of the print head. The rotator 420 may also turn over the first substrate so that the printer prints the second pattern on a second side of the first substrate. Furthermore, the rotator 420 may also position a second substrate so that the printer 418 prints the second pattern on the second substrate.

The electronic device may also include a display 422. The display 422 may indicate the status of the process for printing a grid of electrodes. If a problem develops, the display 422 may communicate an error message to the user of the electronic device 400. The user may intervene using the I/O devices 412.

Communication between various components of the electronic device 400 may be accomplished via one or more busses 406. In some examples, the bus 406 may be a single bus that couples all of the components of the electronic device 400 according to a particular communication protocol. Furthermore, the electronic device 400 may also include any suitable number of busses 406 of varying types, which may use different communication protocols to couple specific components of the electronic device 400 according to the design considerations of a particular implementation.

The block diagram of FIG. 4 is not intended to indicate that the electronic device 400 is to include all of the components shown in FIG. 4. Rather, the electronic device 400 can include fewer or additional components not shown in FIG. 4, depending on the details of the specific implementation. Furthermore, any of the functionalities of the processor 402 may be partially, or entirely, implemented in hardware and/or a processor. For example, the functionality may be implemented in any combination of Application Specific Integrated Circuits (ASICs), Field Programmable Gate Arrays (FPGAs), logic circuits, and the like. In addition, embodiments of the present techniques can be implemented in any suitable electronic device, including ultra-compact form factor devices, such as System-On-a-Chip (SOC), and multi-chip modules.

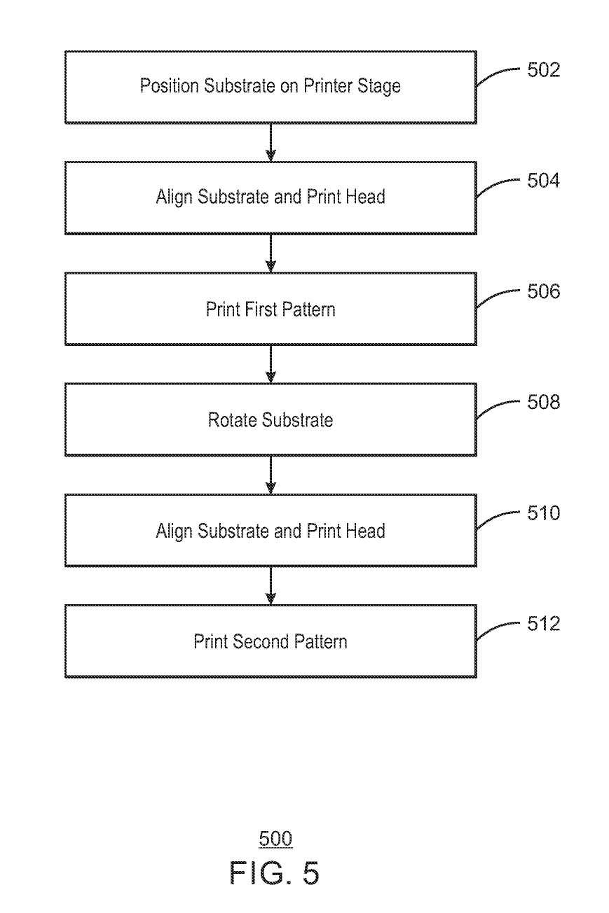

FIG. 5 is a process flow diagram of a method 500 for manufacturing a touch sensor. The method 500 may be performed by the electronic device shown in FIG. 4.

At 502, a substrate may be positioned on a printer stage by a positioner. At 504, the substrate and print head may be aligned. Alignment may be accomplished by lining up fixed cameras with alignment marks on the substrate. The alignment marks may be the same distance apart as the fixed cameras.

At 506, a first pattern of electrodes may be printed. The printed pattern may be parallel to the direction of movement of the print head. At 508, the substrate may be rotated so that a different pair of alignment marks is in position to be aligned with the fixed cameras. At 510, the substrate and print head may be aligned. Alignment may be accomplished by lining up the fixed cameras with the different pair of alignment marks on the substrate.

At 512, a second pattern of electrodes may be printed. The second pattern may also be parallel to the direction of movement of the print head. In this fashion, a grid may be formed without printing electrodes perpendicular to the direction of movement of the print head. As a result, the electrodes of the grid may be formed without jagged edges.

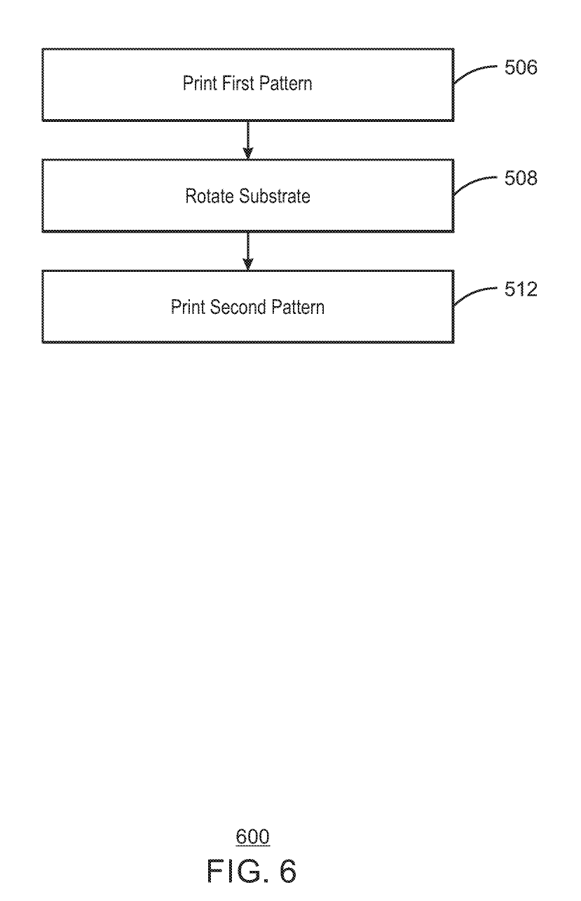

FIG. 6 is a simplified flow diagram of the method 500 shown in FIG. 5. The method 600 may be performed by the electronic device shown in FIG. 4. At 506, a first pattern of electrodes may be printed. The printed pattern may be parallel to the direction of movement of the print head. At 508, the substrate may be rotated so that a different pair of alignment marks may be aligned with the fixed cameras. At 512, a second pattern of electrodes may be printed. The second pattern also may be parallel to the direction of movement of the print head. The method 600 may ensure that both the first pattern and the second pattern are parallel to the direction of movement of the print head. As a result, the second pattern may not have jagged edges because it was not printed perpendicular to the direction of movement of the print head.

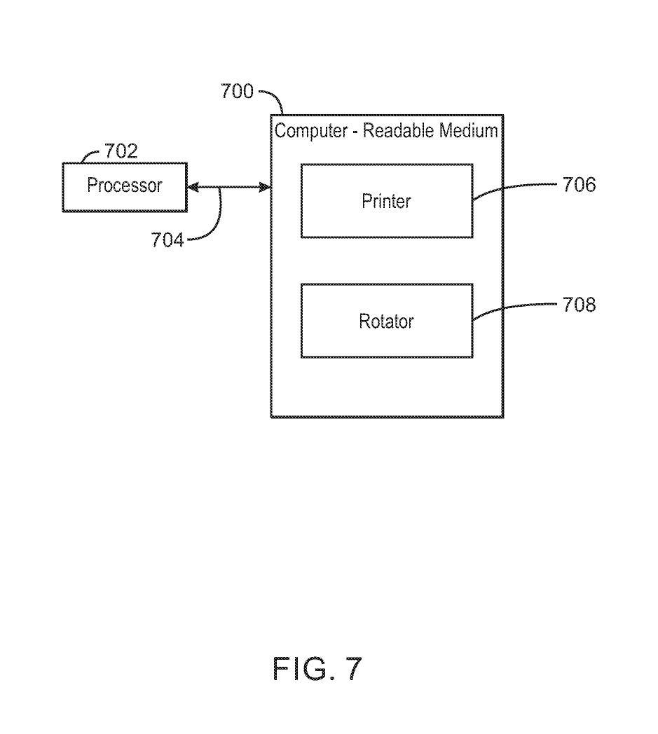

FIG. 7 is a block diagram of a medium 700 containing code to execute the manufacture of a touch sensor. The medium 700 may be a non-transitory computer-readable medium that stores code that can be accessed by a processor 702 via a bus 704. For example, the computer-readable medium 700 can be a volatile or non-volatile data storage device. The medium 700 can also be a logic unit, such as an Application Specific Integrated Circuit (ASIC), a Field Programmable Gate Array (FPGA), or an arrangement of logic gates implemented in one or more integrated circuits, for example.

The medium 700 may include modules 706 and 708 configured to perform the techniques described herein. For example, a printer 706 may be configured to print a first pattern and a second pattern on a substrate. The first pattern may be parallel to a direction of movement of a print head. The first pattern and the second pattern may be perpendicular to each other. A rotator 708 may be configured to rotate the substrate so that the printer prints the second pattern parallel to the movement of the print head

The block diagram of FIG. 7 is not intended to indicate that the medium 700 is to include all of the components shown in FIG. 7. Further, the medium 700 may include any number of additional components not shown in FIG. 7, depending on the details of the specific implementation.

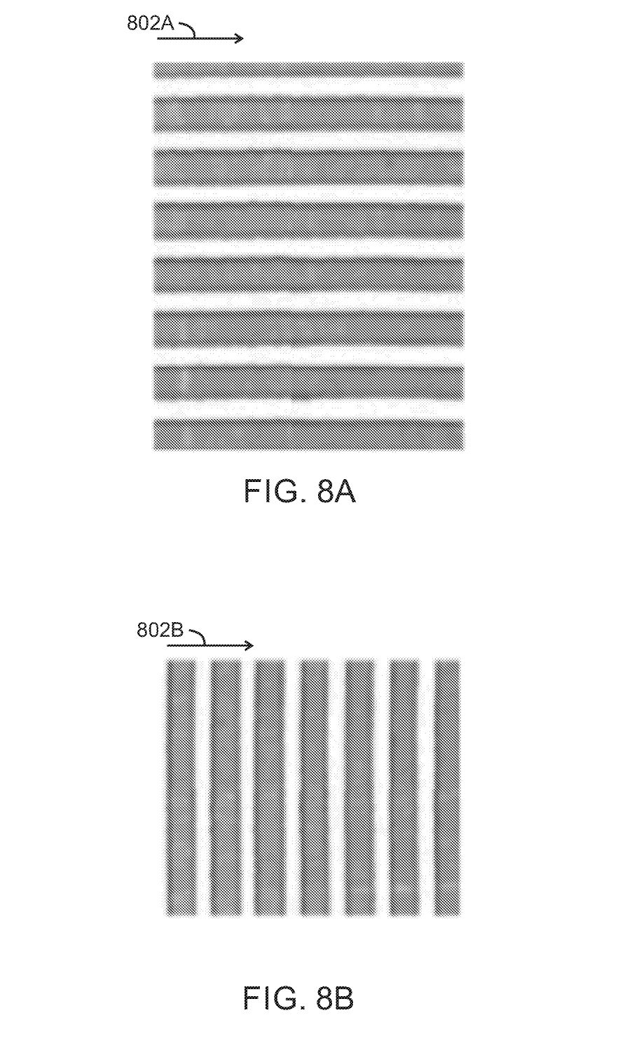

FIGS. 8A and 8B are representations of printed patterns obtained using the touch sensor manufacturing techniques discussed herein. As in FIGS. 1A and 1B, the white bars represent the electrodes of the conductive material and the gray bars represent the substrate exposed by the print head. The direction of movement of the print head is indicated by the arrows 802A and 802B. In FIG. 8A, the printed pattern is substantially parallel to the direction 802A of movement of the print head. In FIG. 8B, the printed pattern is substantially perpendicular to the direction 802B of movement of the print head. However, the jaggedness of the edges is considerably reduced as compared to FIG. 1B. This is because the substrate was rotated before printing of the second pattern. Instead of printing a pattern substantially perpendicular to the direction 802B of movement of the print head, rotation of the substrate enabled the printing of a pattern substantially parallel to the direction 802B of movement of the print head.

### EXAMPLES

Example 1 is an electronic device for manufacturing a touch sensor. The electronic device includes a printer to print a first pattern and a second pattern on a first side of a first substrate, wherein the first pattern is substantially parallel to movement of a print head, and wherein the first pattern and the second pattern are substantially perpendicular to each other; and a rotator to rotate the first substrate so that the printer is to print the second pattern substantially parallel to the movement of the print head.

Example 2 includes the electronic device of example 1, including or excluding optional features. In this example, the electronic device includes a processor, wherein the printer and the rotator comprise code stored in memory of the electronic device and executable by the processor.

Example 3 includes the electronic device of any one of examples 1 to 2, including or excluding optional features. In this example, the first side of the first substrate comprises a silver coating. Optionally, the silver coating is to be selectively removed by printing the first pattern and the second pattern on the first side of the first substrate.

Example 4 includes the electronic device of any one of examples 1 to 3, including or excluding optional features. In this example, a jaggedness of the second pattern is to be reduced by the rotation of the first substrate.

Example 5 includes the electronic device of any one of examples 1 to 4, including or excluding optional features. In this example, the electronic device includes a positioner to position the first substrate on a stage of the printer.

Example 6 includes the electronic device of any one of examples 1 to 5, including or excluding optional features. In this example, the electronic device includes an alignment manager to align the first substrate and the print head. Optionally, the alignment manager comprises a plurality of cameras, the plurality of cameras to align with a plurality of alignment marks on the first side of the first substrate. Optionally, a distance between the plurality of alignment marks in a direction substantially parallel to the movement of the print head is substantially equal to a distance between the plurality of alignment marks in a direction substantially perpendicular to the movement of the print head. Optionally, the distance between the plurality of alignment marks in the direction substantially parallel to the movement of the print head and the distance between the plurality of alignment marks in the direction substantially perpendicular to the movement of the print head are substantially equal to a distance between the plurality of cameras.

Example 7 includes the electronic device of any one of examples 1 to 6, including or excluding optional features. In this example, the rotator is to turn over the first substrate, the printer to print the second pattern on a second side of the first substrate in response to the turning over of the first substrate.

Example 8 includes the electronic device of any one of examples 1 to 7, including or excluding optional features. In this example, the rotator is to position a second substrate on the stage of the printer, the printer to print the second pattern on the second substrate in response to the positioning of the second substrate.

Example 9 is a method for manufacturing a touch sensor. The method includes printing a first pattern substantially parallel to movement of a print head on a first side of a first substrate, the first pattern substantially perpendicular to a second pattern; rotating the first substrate so that the second pattern is substantially parallel to the movement of the print head; and printing the second pattern.

Example 10 includes the method of example 9, including or excluding optional features. In this example, the method includes removing a silver coating by printing the first pattern and the second pattern on the first side of the first substrate.

Example 11 includes the method of any one of examples 9 to 10, including or excluding optional features. In this example, the method includes reducing a jaggedness of the second pattern by the rotation of the first substrate.

Example 12 includes the method of any one of examples 9 to 11, including or excluding optional features. In this example, the method includes positioning the first substrate on a stage of a printer.

Example 13 includes the method of any one of examples 9 to 12, including or excluding optional features. In this example, the method includes aligning the first substrate and the print head. Optionally, aligning the first substrate and the print head comprises aligning a plurality of cameras with a plurality of alignment marks on the first side of the first substrate. Optionally, a distance between the plurality of alignment marks in a direction substantially parallel to the movement of the print head is substantially equal to a distance between the plurality of alignment marks in a direction substantially perpendicular to the movement of the print head. Optionally, the distance between the plurality of alignment marks in the direction substantially parallel to the movement of the print head and the distance between the plurality of alignment marks in the direction substantially perpendicular to the movement of the print head are substantially equal to a distance between the plurality of cameras.

Example 14 includes the method of any one of examples 9 to 13, including or excluding optional features. In this example, the method includes turning over the first substrate and printing the second pattern on a second side of the first substrate. Optionally, the method includes removing the silver coating by printing the second pattern on the second side of the first substrate.

Example 15 includes the method of any one of examples 9 to 14, including or excluding optional features. In this example, the method includes positioning a second substrate on the stage of the printer and printing the second pattern on the second substrate. Optionally, the method includes removing the silver coating by printing the second pattern on the second substrate.

Example 16 is at least one computer-readable medium. The computer-readable medium includes instructions that direct the processor to print a first pattern substantially parallel to movement of a print head on a first side of a first substrate, the first pattern substantially perpendicular to a second pattern; rotate the first substrate so that the second pattern is substantially parallel to the movement of the print head; and print the second pattern.

Example 17 includes the computer-readable medium of example 16, including or excluding optional features. In this example, the computer-readable medium includes instructions to direct the processor to remove a silver coating by printing the first pattern and the second pattern on the first side of the first substrate.

Example 18 includes the computer-readable medium of any one of examples 16 to 17, including or excluding optional features. In this example, the computer-readable medium includes instructions to position the first substrate on a stage of a printer.

Example 19 includes the computer-readable medium of any one of examples 16 to 18, including or excluding optional features. In this example, the computer-readable medium includes instructions to direct the processor to align the first substrate and the print head by aligning a plurality of cameras with a plurality of alignment marks on the first side of the first substrate.

Example 20 includes the computer-readable medium of any one of examples 16 to 19, including or excluding optional features. In this example, the computer-readable medium includes instructions to direct the processor to turn over the first substrate and print the second pattern on a second side of the first substrate.

Example 21 includes the computer-readable medium of any one of examples 16 to 20, including or excluding optional features. In this example, the computer-readable medium includes instructions to direct the processor to position a second substrate on the stage of the printer and print the second pattern on the second substrate.

Example 22 is an apparatus for manufacturing a touch sensor. The apparatus includes a means for printing a first pattern substantially parallel to movement of a print head on a first side of a first substrate, the first pattern substantially perpendicular to a second pattern; a means for rotating the first substrate so that the second pattern is substantially parallel to the movement of the print head; and a means for printing the second pattern.

Example 23 includes the apparatus of example 22, including or excluding optional features. In this example, the apparatus includes a means for removing a silver coating from the first side of the first substrate. Optionally, the means for removing a silver coating comprises the means for printing the first pattern and the second pattern on the first side of the first substrate.

Example 24 includes the apparatus of any one of examples 22 to 23, including or excluding optional features. In this example, the apparatus includes a means for aligning the first substrate and the print head. Optionally, the means for aligning the first substrate and the print head comprises a plurality of cameras and a plurality of alignment marks on the first side of the first substrate.

Example 25 includes the apparatus of any one of examples 22 to 24, including or excluding optional features. In this example, the apparatus includes a means for turning over the first substrate and a means for printing the second pattern on a second side of the first substrate. Optionally, the means for turning over the first substrate is a rotator.

Example 26 includes the apparatus of any one of examples 22 to 25, including or excluding optional features. In this example, the apparatus includes a means for positioning a second substrate on the stage of the printer and a means for printing the second pattern on the second substrate. Optionally, the means for positioning a second substrate on the stage of the printer is the rotator.

Example 27 is a system for manufacturing a touch sensor. The system includes a processor; and a memory storing code executable by the processor to: print a first pattern and a second pattern on a first side of a first substrate, wherein the first pattern is substantially parallel to movement of a print head, and wherein the first pattern and the second pattern are substantially perpendicular to each other; and rotate the first substrate so that the printer is to print the second pattern substantially parallel to the movement of the print head.

Example 28 includes the system of example 27, including or excluding optional features. In this example, the first substrate comprises a silver coating. Optionally, the silver coating is to be selectively removed by printing the first pattern and the second pattern on the first side of the first substrate.

Example 29 includes the system of any one of examples 27 to 28, including or excluding optional features. In this example, a jaggedness of the second pattern is to be reduced by the rotation of the first substrate.

Example 30 includes the system of any one of examples 27 to 29, including or excluding optional features. In this example, the memory stores code executable by the processor to position the first substrate on a stage of a printer.

Example 31 includes the system of any one of examples 27 to 30, including or excluding optional features. In this example, the memory stores code executable by the processor to align the first substrate and the print head. Optionally, the memory stores code executable by the processor to align a plurality of cameras with a plurality of alignment marks on the first side of the first substrate to align the first substrate and the print head. Optionally, a distance between the plurality of alignment marks in a direction substantially parallel to the movement of the print head is substantially equal to a distance between the plurality of alignment marks in a direction substantially perpendicular to the movement of the print head. Optionally, the distance between the plurality of alignment marks in the direction substantially parallel to the movement of the print head and the distance between the plurality of alignment marks in the direction substantially perpendicular to the movement of the print head are substantially equal to a distance between the plurality of cameras.

Example 32 includes the system of any one of examples 27 to 31, including or excluding optional features. In this example, the memory stores code executable by the processor to: turn over the first substrate; and print the second pattern on a second side of the first substrate.

Example 33 includes the system of any one of examples 27 to 32, including or excluding optional features. In this example, the memory stores code executable by the processor to: position a second substrate on the stage of the printer; and print the second pattern on the second substrate.

Some embodiments may be implemented in one or a combination of hardware, firmware, and software. Some embodiments may also be implemented as instructions stored on the tangible, non-transitory, machine-readable medium, which may be read and executed by a computing platform to perform the operations described. In addition, a machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the method or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

1-25. (canceled)

26. An electronic device for manufacturing a touch sensor, comprising:
a printer to print a first pattern and a second pattern on a first side of a first substrate, wherein the first pattern is substantially parallel to movement of a print head, and wherein the first pattern and the second pattern are substantially perpendicular to each other; and
a rotator to rotate the first substrate so that the printer is to print the second pattern substantially parallel to the movement of the print head.

27. The electronic device of claim 26, comprising a processor, wherein the printer and the rotator comprise code stored in memory of the electronic device and executable by the processor.

28. The electronic device of claim 26, wherein the first side of the first substrate comprises a silver coating.

29. The electronic device of claim 28, wherein the silver coating is to be selectively removed by printing the first pattern and the second pattern on the first side of the first substrate.

30. The electronic device of claim 26, wherein a jaggedness of the second pattern is to be reduced by the rotation of the first substrate.

31. The electronic device of claim 26, comprising a positioner to position the first substrate on a stage of the printer.

32. The electronic device of claim 26, comprising an alignment manager to align the first substrate and the print head.

33. The electronic device of claim 32, wherein the alignment manager comprises a plurality of cameras, the plurality of cameras to align with a plurality of alignment marks on the first side of the first substrate.

34. The electronic device of claim 33, wherein a distance between the plurality of alignment marks in a direction substantially parallel to the movement of the print head is substantially equal to a distance between the plurality of alignment marks in a direction substantially perpendicular to the movement of the print head.

35. The electronic device of claim 34, wherein the distance between the plurality of alignment marks in the direction substantially parallel to the movement of the print head and the distance between the plurality of alignment marks in the direction substantially perpendicular to the movement of the print head are substantially equal to a distance between the plurality of cameras.

36. The electronic device of claim 26, wherein the rotator is to turn over the first substrate, the printer to print the second pattern on a second side of the first substrate in response to the turning over of the first substrate.

37. The electronic device of claim 26, wherein the rotator is to position a second substrate on the stage of the printer, the printer to print the second pattern on the second substrate in response to the positioning of the second substrate.

38. A method for manufacturing a touch sensor, comprising:
printing a first pattern substantially parallel to movement of a print head on a first side of a first substrate, the first pattern substantially perpendicular to a second pattern;
rotating the first substrate so that the second pattern is substantially parallel to the movement of the print head; and
printing the second pattern.

39. The method of claim 38, comprising aligning the first substrate and the print head.

40. The method of claim 39, wherein aligning the first substrate and the print head comprises aligning a plurality of cameras with a plurality of alignment marks on the first side of the first substrate.

41. The method of claim 40, wherein a distance between the plurality of alignment marks in a direction substantially parallel to the movement of the print head is substantially equal to a distance between the plurality of alignment marks in a direction substantially perpendicular to the movement of the print head.

42. The method of claim 41, wherein the distance between the plurality of alignment marks in the direction substantially parallel to the movement of the print head and the distance between the plurality of alignment marks in the direction substantially perpendicular to the movement of the print head are substantially equal to a distance between the plurality of cameras.

43. At least one computer-readable medium, comprising instructions to direct a processor to:
print a first pattern substantially parallel to movement of a print head on a first side of a first substrate, the first pattern substantially perpendicular to a second pattern;
rotate the first substrate so that the second pattern is substantially parallel to the movement of the print head; and
print the second pattern.

44. The at least one computer-readable medium of claim 43, comprising instructions to direct the processor to remove a silver coating by printing the first pattern and the second pattern on the first side of the first substrate.

45. The at least one computer-readable medium of claim 43, comprising instructions to direct the processor to align the first substrate and the print head by aligning a plurality of cameras with a plurality of alignment marks on the first side of the first substrate.

46. An apparatus for manufacturing a touch sensor, comprising:
means for printing a first pattern substantially parallel to movement of a print head on a first side of a first substrate, the first pattern substantially perpendicular to a second pattern;
means for rotating the first substrate so that the second pattern is substantially parallel to the movement of the print head; and
means for printing the second pattern.

47. The apparatus of claim 46, comprising means for removing a silver coating from the first side of the first substrate.

48. The apparatus of claim 47, wherein the means for removing a silver coating comprises the means for printing the first pattern and the means for printing the second pattern.

49. The apparatus of claim 46, comprising means for aligning the first substrate and the print head.

50. The apparatus of claim 49, wherein the means for aligning the first substrate and the print head comprises a plurality of cameras and a plurality of alignment marks on the first side of the first substrate.
